(19) United States
(12) Patent Application Publication
(10) Pub. No.: US 2023/0291149 A1
(43) Pub. Date: Sep. 14, 2023

(54) CONNECTOR DEVICE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Shinji TANAKA, Mie (JP); Yutaka KOBAYASHI, Mie (JP)

(21) Appl. No.: 18/016,775

(22) PCT Filed: Jul. 16, 2021
(86) PCT No.: PCT/JP2021/026809

§ 371 Date: Jan. 18, 2023

(30) Foreign Application Priority Data
Aug. 6, 2020 (JP) 2020-133699

(51) Int. Cl. H01R 13/631; H01R 12/91; H01R 24/50; H01R 24/54

(52) U.S. Cl. CPC H01R 13/6315; H01R 12/91; H01R 24/50; H01R 24/54

(57) ABSTRACT

It is aimed for miniaturization. A connector device is provided with a first connector, a second connector provided to face the first connector, an adapter for connecting the first and second connectors, posture holding portions provided on the first connector and the adapter and configured to hold the adapter in a constant posture with respect to the first connector by coming into contact with each other, a resilient holding portion provided on the adapter and configured to hold the first posture holding portion of the first connector and the movable posture holding portion of the adapter in a state in contact with each other by a resilient force, and a first guide portion and a second guide portion for correcting position shifts of the second connector and the adapter by inclining the adapter while resiliently deforming the resilient holding portion.

### TECHNICAL FIELD

The present disclosure relates to a connector device.

### BACKGROUND

Patent Document 1 discloses a structure for connecting a first connector and a second connector facing each other via an adapter. The adapter is supported in the first connector and can rock to be inclined with respect to a facing direction of the both connectors. The second connector is formed with a guide portion spreading into a flare shape. If the first and second connectors are connected while being shifted in position, the adapter rocks by bringing a tip part thereof into sliding contact with the guide portion and is connected to the second connector.

### PRIOR ART DOCUMENT

### Patent Document

Patent Document 1: US 2012/0295478 A

### SUMMARY OF THE INVENTION

### Problems to be Solved

If the first connector, the second connector and the adapter are arranged in such a posture that axes are horizontally oriented, there is a concern that the adapter is inclined obliquely downward by its own weight. As a countermeasure against this, it is considered to largely expand a width of the guide portion provided in the second connector. However, this enlarges a connector device as a whole.

A connector device of the present disclosure was completed on the basis of the above situation and aims for miniaturization.

### Means to Solve the Problem

The present disclosure is directed to a connector device with a first connector, a second connector provided to face the first connector, an adapter for connecting the first and second connectors, posture holding portions provided on the first connector and the adapter, the posture holding portions holding the adapter in a constant posture with respect to the first connector by coming into contact with each other, a resilient holding portion provided on at least one of the first connector and the adapter, the resilient holding portion holding the posture holding portion of the first connector and the posture holding portion of the adapter in a state in contact with each other by a resilient force, and a guide portion for correcting position shifts of the second connector and the adapter by inclining the adapter while resiliently deforming the resilient holding portion.

### Effect of the Invention

According to the present disclosure, miniaturization can be achieved.

### BRIEF DESCRIPTION OF THE DRAWINGS

FIG. 1 is a side view in section of a first connector constituting a connector device of one embodiment.

FIG. 2 is a perspective view of an adapter.

FIG. 3 is a side view in section showing a state where the adapter is held in the first connector.

FIG. 4 is a side view in section of a second connector.

FIG. 5 is a side view in section showing a state where the first and second connectors are shifted in position in a vertical direction and the adapter is in contact with a guide portion of the second connector.

FIG. 6 is a plan view in section showing the state where the adapter is connected to the second connector with the first and second connectors shifted in position in a horizontal direction.

### DETAILED DESCRIPTION TO EXECUTE THE INVENTION

### Description of Embodiments of Present Disclosure

First, embodiments of the present disclosure are listed and described.
(1) The connector device of the present disclosure is provided with a first connector, a second connector provided to face the first connector, an adapter for connecting the first and second connectors, posture holding portions provided on the first connector and the adapter, the posture holding portions holding the adapter in a constant posture with respect to the first connector by coming into contact with each other, a resilient holding portion provided on at least one of the first connector and the adapter, the resilient holding portion holding the posture holding portion of the first connector and the posture holding portion of the adapter in a state in contact with each other by a resilient force, and a guide portion for correcting position shifts of the second connector and the adapter by inclining the adapter while resiliently deforming the resilient holding portion. According to the configuration of the present disclosure, the adapter can be held in the constant posture with respect to the first connector by bringing the posture holding portion of the first connector and that of the adapter into contact by the resilient force of the resilient holding portion. The position shifts of the second connector and the adapter are corrected by the guide portion inclining the posture of the adapter against the resilient force of the resilient holding portion. In setting a guide area by the guide portion, the posture inclination of the adapter with respect to the first connector needs not be considered. Since it is sufficient to suppress the guide area by the guide portion to a minimum dimension necessary to absorb position shifts of the first and second connectors, the connector device can be reduced in size in a rocking direction of the adapter.
(2) Preferably, a first posture holding portion serving as the posture holding portion of the first connector and a movable posture holding portion serving as the posture holding portion of the adapter are constituted by flat surfaces configured to come into surface contact with each other. According to this configuration, the posture of the adapter can be stably held.
(3) Preferably, the first posture holding portion serving as the posture holding portion of the first connector is formed on a first dielectric constituting the first connector. According to this configuration, the number of components can be reduced as compared to the case where the first posture holding portion is formed on a dedicated component separate from the first dielectric.
(4) Preferably, the movable posture holding portion serving as the posture holding portion of the adapter is formed on a movable dielectric constituting the adapter. According to this configuration, the number of components can be reduced as compared to the case where the movable posture holding portion is formed on a dedicated component separate from the movable dielectric.
(5) Preferably, the resilient holding portion is formed on a movable outer conductor constituting the adapter. According to this configuration, the number of components can be reduced as compared to the case where the resilient holding portion is formed on a dedicated component separate from the movable outer conductor.
(6) Preferably, in (5), the resilient holding portion includes a contact point portion for electrically conductively connecting the movable outer conductor to a first outer conductor constituting the first connector. According to this configuration, since the resilient holding portion also has an electrical conduction function between the movable outer conductor and the first outer conductor, the shape of the movable outer conductor can be simplified as compared to the case where a dedicated contact point portion is provided separately from the resilient holding portion.

### Details of Embodiment of Present Disclosure

### Embodiment

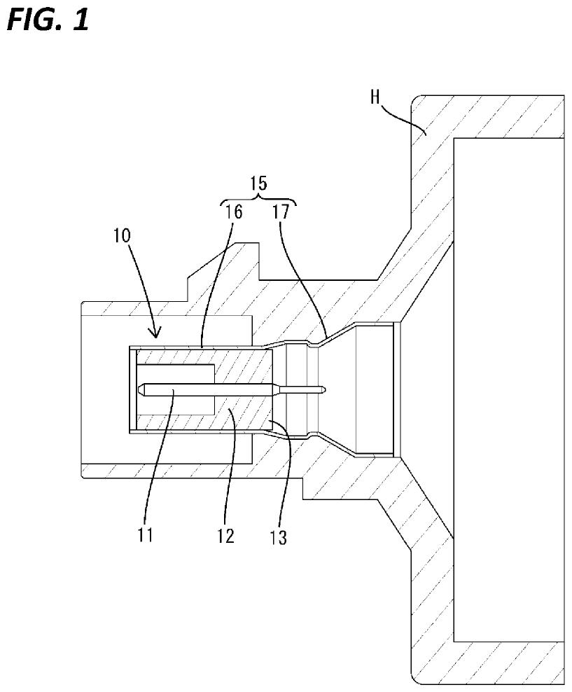

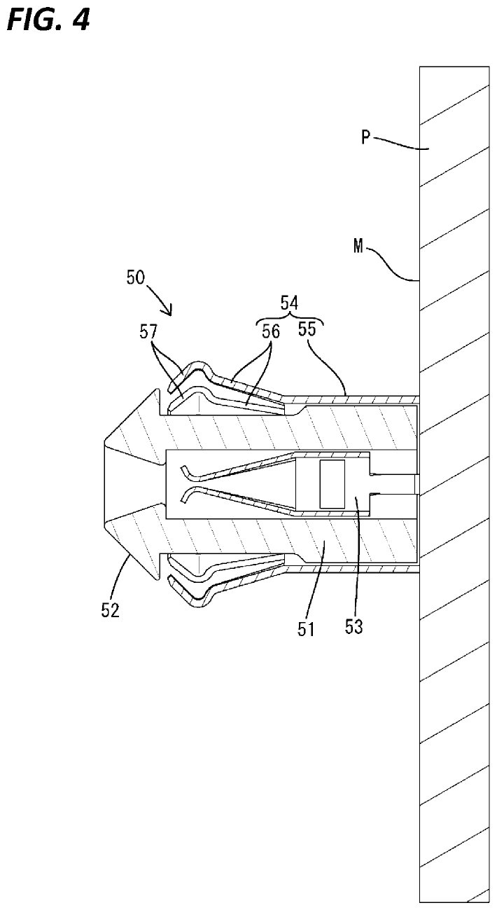

A specific embodiment of a connector device of the present disclosure is described below with reference to FIGS. 1 to 6. Note that the present invention is not limited to these illustrations, but is represented by claims and intended to include all changes in the scope of claims and in the meaning and scope of equivalents. A connector device of this embodiment is provided with a first connector 10, an adapter 30 and a second connector 50. In this embodiment, a right side in FIGS. 1, 3, 5 and 6 is defined as a front side concerning front-rear directions of the first connector 10 and the adapter 30. A left side in FIGS. 4 to 6 is defined as a front side concerning a front-rear direction of the second connector 50.

<First Connector 10>

As shown in FIG. 1, the first connector 10 is connected, for example, to an in-vehicle camera (not shown) while being accommodated in a housing H. The first connector 10 includes a first inner conductor 11 having an axis oriented in the front-rear direction, a tubular first dielectric 12 having an axis oriented in the front-rear direction and a hollow cylindrical first outer conductor 15 having an axis oriented in the front-rear direction. The first inner conductor 11 is mounted to be coaxially passed through the first dielectric 12. A first posture holding portion 13 is formed in a front end part of the first dielectric 12. The front surface of the first posture holding portion 13, i.e., a surface facing the adapter 30 in an axial direction of the first connector 10, serves as a first posture holding surface 14, which is a flat surface orthogonal to an axis of the first connector 10.

The first outer conductor 15 is a single component including a constant diameter portion 16 having a circular cross-section and fit to the outer periphery of the first dielectric 12 and a receptacle 17 having a circular cross-section and projecting forward from the front end of the constant diameter portion 16. The receptacle 17 includes a pressure receiving portion 18, a retaining portion 19, a tapered portion 20 and an enlarged diameter portion 21. The first outer conductor 15 is mounted on the first dielectric 12 with the constant diameter portion 16 coaxially fit to the outer periphery of the first dielectric 12. The receptacle 17 is arranged forward of the first dielectric 12. An entire region of the outer peripheral surface of the first outer conductor 15 in the axial direction is fixed while being held in close contact with the inner peripheral surface of the housing H.

The pressure receiving portion 18 is shaped to coaxially project forward from the front end of the constant diameter portion 16. An inner diameter of the pressure receiving portion 18 is larger than that of the constant diameter portion 16. The retaining portion 19 is shaped to extend forward from the front end of the pressure receiving portion 18. A minimum inner diameter of the retaining portion 19 is smaller than a maximum inner diameter of the pressure receiving portion 18. The tapered portion 20 is shaped to extend forward from the front end of the retaining portion 19 and be gradually enlarged in diameter toward the front. A maximum inner diameter of the tapered portion 20 is larger than that of the pressure receiving portion 18. The enlarged diameter portion 21 is shaped to extend forward from the front end of the tapered portion 20. A maximum inner diameter of the enlarged diameter portion 21 is constant and equal to that of the tapered portion 20.

<Adapter 30>

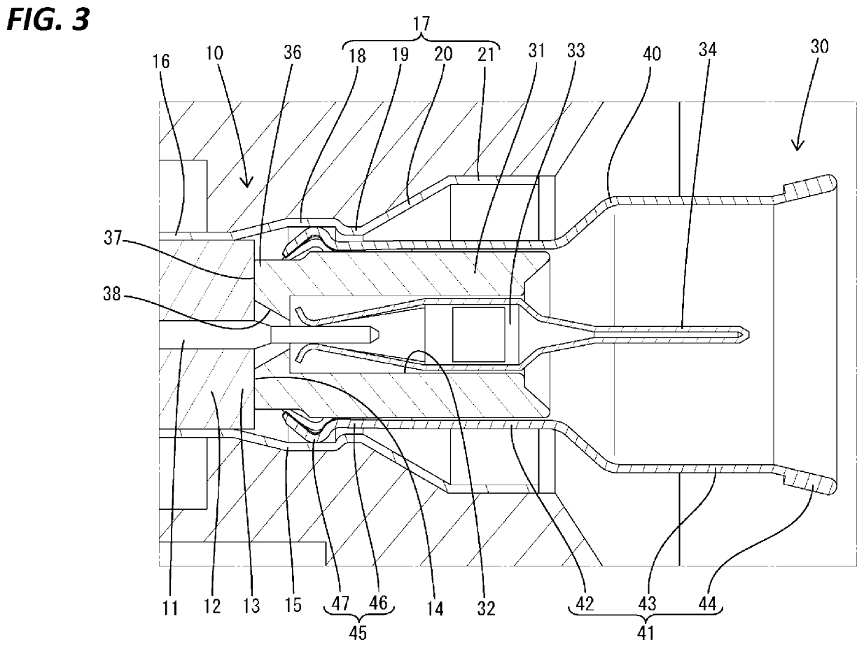

As shown in FIG. 3, the adapter 30 includes a tubular movable dielectric 31, an elongated movable inner conductor 33 and a movable outer conductor 40. The movable dielectric 31 is formed with an inner conductor accommodation chamber 32 shaped to penetrate through the movable dielectric 31 in an axial direction. The movable inner conductor 33 includes a tab 34 projecting forward from the front end of the movable dielectric 31. The movable inner conductor 33 is mounted into the movable dielectric 31. An entire region of the movable inner conductor 33 behind the tab 34 is accommodated in the inner conductor accommodation chamber 32.

A movable posture holding portion 36 is formed in a rear end part of the movable dielectric 31. The rear surface of the movable posture holding portion 36, i.e., a surface facing the first posture holding surface 14 in the axial direction of the adapter 30, functions as a movable posture holding surface 37, which is a flat surface orthogonal to an axis of the adapter 30. The movable posture holding portion 36 is formed with a connection hole 38 allowing the inner conductor accommodation chamber 32 to be open in the movable posture holding surface 37. The connection hole 38 is tapered to gradually increase an inner diameter toward the rear.

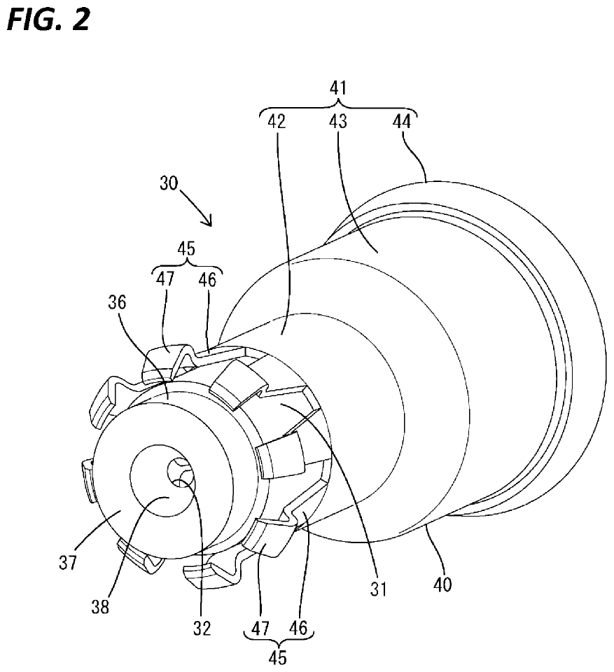

As shown in FIG. 2, the movable outer conductor 40 is a single component including a hollow cylindrical outer conductor body portion 41 and a plurality of resilient holding portions 45 spaced apart in a circumferential direction. As shown in FIG. 3, the outer conductor body portion 41 includes a small diameter portion 42, a large diameter portion 43 and a guided portion 44. The small diameter portion 42 is formed in a rear end part of the outer conductor body portion 41. The large diameter portion 43 has a larger diameter than the small diameter portion 42 and projects forward from the front end of the small diameter portion 42. The large diameter portion 43 is located forward of the front end of the movable dielectric 31 and surrounds the tab 34 of the movable inner conductor 33. The guided portion 44 is formed in a front end part of the large diameter portion 43 and located in a front end part of the movable outer conductor 40. The guided portion 44 is formed into a tapered hollow cylindrical shape enlarged in diameter toward the front.

The plurality of resilient holding portions 45 are arranged at equal angular intervals in the circumferential direction and cantilevered rearward from the rear end edge of the small diameter portion 42. The resilient holding portion 45 includes a base portion 46 extending rearward in parallel to an axis of the movable outer conductor 40 and a contact point portion 47 connected to the rear end of the base portion 46. The contact point portion 47 is arranged in a rear end part (extending end part) of the resilient holding portion 45. The contact point portion 47 is shaped to bulge further radially outward than the base portion 46. The movable outer conductor 40 is coaxially mounted on the movable dielectric 31 while surrounding the movable dielectric 31 by the small diameter portion 42 and the resilient holding portions 45.

As shown in FIG. 3, the adapter 30 is mounted in the first connector 10. The adapter 30 is located forward of the first connector 10 and arranged side by side with the first connector 10 in the front-rear direction. With the adapter 30 mounted in the first connector 10, the movable posture holding surface 37 is held in surface contact with the first posture holding surface 14. By the contact of the first posture holding surface 14 and the movable posture holding surface 37, the adapter 30 is held in a state positioned in a posture coaxial with the first connector 10. Since the axes of the first connector 10 and the adapter 30 are horizontally oriented, there is a concern that the posture of the adapter 30 is inclined downward by the weight of the adapter 30 with the lower end of the movable posture holding surface 37 as a fulcrum. However, the posture inclination of the adapter 30 is prevented by the resilient holding portions 45 as described next.

The contact point portions 47 of the plurality of resilient holding portions 45 are resiliently in contact with the inner peripheral surface of the pressure receiving portion 18 in a radially outward direction at a plurality of positions spaced apart in the circumferential direction. The contact positions of the contact point portions 47 are positions separated forward in the axial direction from the contact position of the first posture holding surface 14 and the movable posture holding surface 37. Accordingly, even if the adapter 30 is going to be inclined downward with the lower end of the movable posture holding surface 37 as a fulcrum, the resilient holding portions 45 located on a lower end side of the adapter 30 support the adapter 30 from below by resilient forces of those resilient holding portions 45. In this way, the posture inclination of the adapter 30 with respect to the first connector 10 is restricted and the adapter 30 is held in a horizontal posture coaxial with the first connector 10.

The retaining portion 19 of the first outer conductor 15 is located at a position in front of and near the contact point portions 47. Accordingly, if the adapter 30 is going to be inclined downward with the lower end of the movable posture holding surface 37 as a fulcrum, the contact point portions 47 located in an upper end part, out of the plurality of contact point portions 47, lock the retaining portion 19 from behind. The downward inclination of the adapter 30 is prevented also by this locking action.

As described above, with the adapter 30 coaxially held with respect to the first connector 10, a front end part of the movable inner conductor 33 enters the inner conductor accommodation chamber 32 through the connection hole 38 and is electrically conductively connected to a rear end part of the movable inner conductor 33. The contact point portions 47 of the movable outer conductor 40 resiliently come into contact with the pressure receiving portion 18 of the first outer conductor 15, whereby the movable outer conductor 40 and the first outer conductor 15 are electrically conductively connected. A clearance in a radial direction is secured over an entire periphery between a region forward of the retaining portion 19, out of the inner peripheral surface of the receptacle 17 of the first outer conductor 15, and the outer peripheral surface of the adapter 30.

<Second Connector 50>

As shown in FIG. 4, the second connector 50 is fixedly mounted with an axis held perpendicular to a mounting surface M of a circuit board P, i.e., with the axis oriented in parallel to the first connector 10. The second connector 50 is provided with a hollow cylindrical second dielectric 51 having an axis oriented in the front-rear direction, a second inner conductor 53 coaxially mounted in the second dielectric 51, and a second outer conductor 54 coaxially mounted on the outer periphery of the second dielectric 51. A first guide portion 52 having a truncated conical shape and coaxial with the second dielectric 51 is formed in a front end part (tip part) of the second dielectric 51. A diameter of the first guide portion 52 is minimum in the front end of the first guide portion 52 and maximum in the rear end of the first guide portion 52.

The second outer conductor 54 surrounds a region of the second dielectric 51 behind (closer to the circuit board P) the first guide portion 52. The second outer conductor 54 includes a hollow cylindrical mounting portion 55 fixed to the mounting surface M and a plurality of resilient pieces 56 cantilevered forward from the front end edge of the mounting portion 55. The plurality of resilient pieces 56 are arranged at fixed intervals in a circumferential direction. A second guide portion 57 is formed in a front end part of the resilient piece 56. The second guide portion 57 is arranged obliquely behind the first guide portion 52 on an outer peripheral side of the first guide portion 52.

<Functions and Effects of Embodiment>

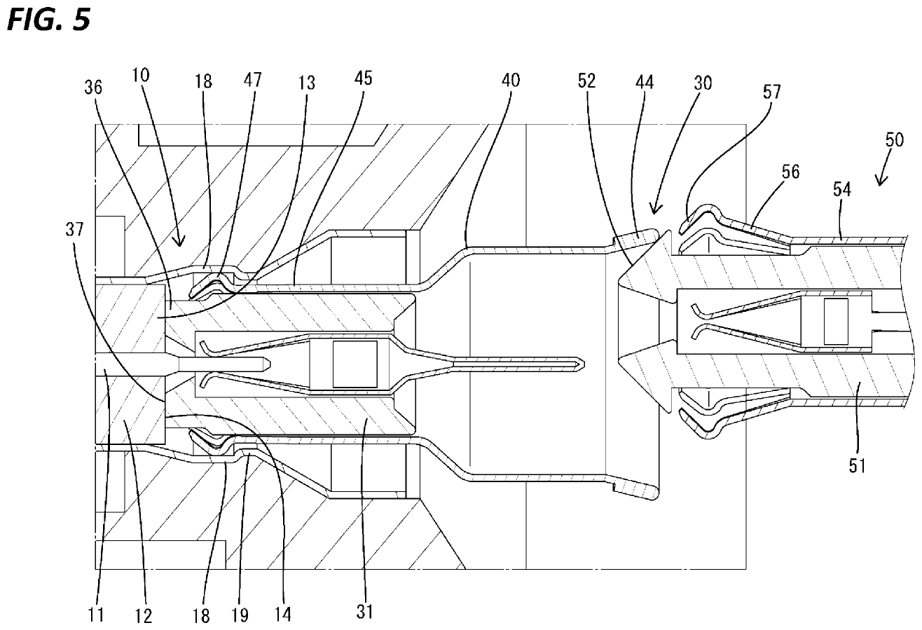

A process of connecting the first connector 10 and the second connector 50 with the second connector 50 positionally shifted relatively upward with respect to the first connector 10 is described. If the first and second connectors 10, 50 are brought closer while facing each other with the axes thereof held in parallel, an upper end part of the front end of the guided portion 44 comes into contact with an upper end part of the first guide portion 52 as shown in FIG. 5. At this time, the adapter 30 is held coaxially with the first connector 10.

If the first and second connectors 10, 50 are further brought closer from this state, the guided portion 44 slides in contact with the first guide portion 52 and the front end part of the adapter 30 is pushed up by the inclination of the first guide portion 52. At this time, the adapter 30 is set in an oblique upward facing posture with the upper ends of the movable posture holding portion 36 and the movable posture holding surface 37 as a fulcrum, and the movable posture holding surface 37 is separated from the first posture holding surface 14 while becoming oblique to the first posture holding surface 14.

If the first and second connectors 10, 50 are further brought closer, the guided portion 44 rides onto the second guide portions 57 from the outer peripheral edge of the first guide portion 52 and the adapter 30 is further inclined by the inclination of the second guide portions 57. Since the clearance is secured in the radial direction between the small diameter portion 42 of the movable outer conductor 40 and the receptacle 17 of the first outer conductor 15, the movable outer conductor 40 does not interfere with the first outer conductor 15 and does not hinder a posture inclining movement of the adapter 30.

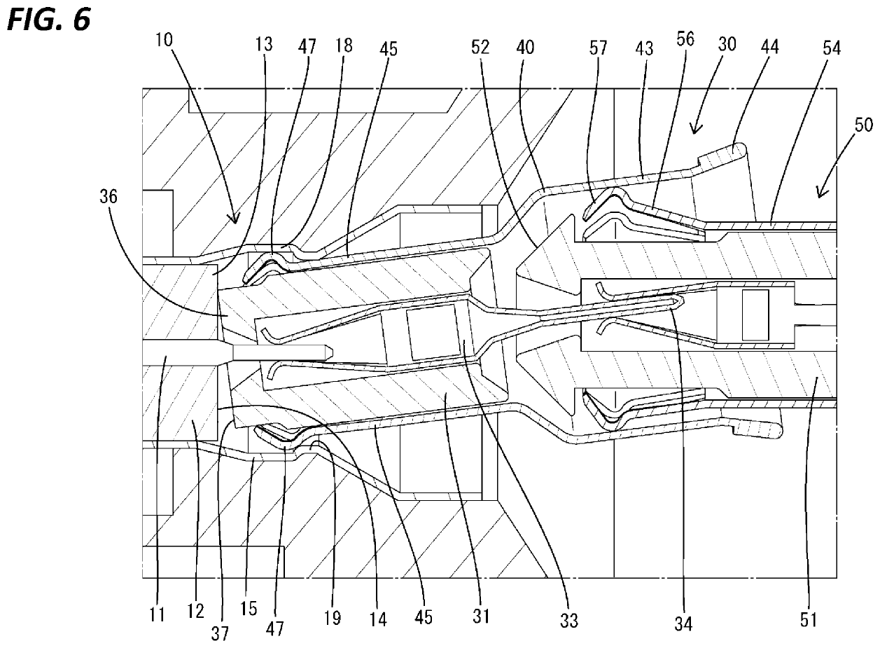

After the guided portion 44 passes through the second guide portions 57, the first and second connectors 10, 50 are further connected with the large diameter portion 43 of the adapter 30 held in sliding contact with the resilient pieces 56. During this time, the second inner conductor 53 and the tab 34 of the movable inner conductor 33 are connected and the first and second connectors 10, 50 are connected. By an oblique upward displacement of the adapter 30 in a side view as shown in FIG. 6, position shifts of the first and second connectors 10, 50 in the vertical direction are absorbed and the first and second connectors 10, 50 are properly connected. Since the respective contact point portions 47 are resiliently in contact with the pressure receiving portion 18 of the first outer conductor 15 by resilient forces of the resilient holding portions 45, the first outer conductor 15 and the movable outer conductor 40 are electrically conductively connected.

The connector device of this embodiment is provided with the first connector 10, the second connector 50 provided to face the first connector 10 and the adapter 30 for connecting the first and second connectors 10, 50. The first connector 10 is provided with the first posture holding portion 13, and the adapter 30 is provided with the movable posture holding portion 36. The first posture holding portion 13 and the movable posture holding portion 36 come into contact with each other, whereby the adapter 30 is held in a constant posture, i.e., in a coaxial posture, with respect to the first connector 10. The adapter 30 is provided with the plurality of resilient holding portions 45.

The resilient holding portions 45 hold the first posture holding portion 13 and the movable posture holding portion 36 in a state in contact with each other by resilient forces of the resilient holding portions 45. The second connector 50 includes the first guide portion 52 and the second guide portions 57. The first and second guide portions 52, 57 correct position shifts of the second connector 50 and the adapter 30 by inclining the adapter 30 while resiliently deforming the resilient holding portions 45.

According to the connector device of this embodiment, the adapter 30 can be held in a constant posture, i.e., in a posture in which the axis is horizontally oriented, with respect to the first connector 10 by bringing the first posture holding portion 13 of the first connector 10 and the movable posture holding portion 36 of the adapter 30 into contact by resilient forces of the resilient holding portions 45. Since the first posture holding portion 13 and the movable posture holding portion 36 are constituted by flat surfaces to be held in surface contact with each other, the posture of the adapter 30 can be stably held.

The position shifts of the second connector 50 and the adapter 30 are corrected by the first and second guide portions 52, 57 inclining the posture of the adapter 30 against the resilient forces of the resilient holding portions 45. In setting a guide area by the first and second guide portions 52, 57, the posture inclination of the adapter 30 with respect to the first connector 10 needs not be considered. It is sufficient to suppress the guide area by the first and second guide portions 52, 57 to a minimum dimension necessary to absorb the position shifts of the first and second connectors 10, 50. Therefore, the connector device of this embodiment can be reduced in size in a rocking direction of the adapter 30.

The first posture holding portion 13 of the first connector 10 is integrally formed to the first dielectric 12 constituting the first connector 10. Therefore, the connector device of this embodiment has a smaller number of components as compared to the case where the first posture holding portion 13 is formed on a dedicated component separate from the first dielectric 12. The movable posture holding portion 36 of the adapter 30 is formed on the movable dielectric 31 constituting the adapter 30. Therefore, the connector device of this embodiment has a smaller number of components as compared to the case where the movable posture holding portion 36 is formed on a dedicated component separate from the movable dielectric 31. The resilient holding portions 45 are formed on the movable outer conductor 40 constituting the adapter 30. Therefore, the connector device of this embodiment has a smaller number of components as compared to the case where the resilient holding portions 45 are formed on a dedicated component separate from the movable outer conductor 40.

The resilient holding portions 45 include the contact point portions 47 for electrically conductively connecting the movable outer conductor 40 to the first outer conductor 15 constituting the first connector 10. According to this configuration, since the resilient holding portions 45 also have an electrical conduction function between the movable outer conductor 40 and the first outer conductor 15, the shape of the movable outer conductor 40 can be simplified as compared to the case where dedicated contact point portions 47 are provided separately from the resilient holding portions 45.

### OTHER EMBODIMENTS

The present invention is not limited to the above described and illustrated embodiment, but is represented by claims. The present invention is intended to include all changes in the scope of claims and in the meaning and scope of equivalents and also include the following embodiments.

Although the resilient holding portions are formed only on the adapter in the above embodiment, the resilient holding portions may be formed only on the first connector or may be formed on both the adapter and the first connector.

Although both the first posture holding portion and the movable posture holding portion are constituted by flat surfaces in the above embodiment, one posture holding portion may be constituted by a flat surface and the other posture holding portion may be ring-shaped to be held in line contact with the one posture holding portion.

Although the adapter is held in the posture parallel to a connecting direction of the both connectors by the posture holding portions in the above embodiment, the adapter may be held in a posture oblique to the connecting direction of the both connectors.

Although the first posture holding portion is formed on the first dielectric in the above embodiment, the first posture holding portion may be formed on a dedicated component separate from the first dielectric.

Although the movable posture holding portion of the adapter is formed on the movable dielectric in the above embodiment, the movable posture holding portion may be formed on the movable outer conductor or a dedicated component separate from the movable dielectric.

Although the movable resilient holding portions are formed on the movable outer conductor in the above embodiment, the movable resilient holding portions may be formed on a dedicated component separate from the movable outer conductor.

Although the resilient holding portions include the contact point portions of the movable outer conductor in the above embodiment, dedicated contact point portions may be provided separately from the resilient holding portions.

Although the resilient holding portions come into contact with the first outer conductor in the above embodiment, the resilient holding portions may come into contact with a part other than the first outer conductor.

Although the first connector is mounted on the housing and the second connector is mounted on the circuit board in the above embodiment, the first connector may be mounted on the circuit board and the second connector may be connected to the housing.

The connector device of the present disclosure is not limited to a shield connector for in-vehicle camera and can also be applied to a shield connector for other use.

### LIST OF REFERENCE NUMERALS

H . . . Housing
M . . . Mounting surface
P . . . Circuit board
10 . . . First connector
11 . . . First inner conductor
12 . . . First dielectric
13 . . . First posture holding portion
14 . . . First posture holding surface
15 . . . First outer conductor
16 . . . Constant diameter portion
17 . . . Receptacle
18 . . . Pressure receiving portion
19 . . . Retaining portion
20 . . . Tapered portion
21 . . . Enlarged diameter portion
30 . . . Adapter
31 . . . Movable dielectric
32 . . . Inner conductor accommodation chamber
33 . . . Movable inner conductor
34 . . . Tab
36 . . . Movable posture holding portion
37 . . . Movable posture holding surface
38 . . . Connection hole
40 . . . Movable outer conductor
41 . . . Outer conductor body portion
42 . . . Small diameter portion
43 . . . Large diameter portion
44 . . . Guided portion
45 . . . Resilient holding portion
46 . . . Base portion
47 . . . Contact point portion
50 . . . Second connector
51 . . . Second dielectric
52 . . . First guide portion
53 . . . Second inner conductor
54 . . . Second outer conductor
55 . . . Mounting portion
56 . . . Resilient piece
57 . . . Second guide portion

1. A connector device, comprising:
a first connector;
a second connector provided to face the first connector;
an adapter for connecting the first and second connectors;
posture holding surfaces provided on the first connector and the adapter, the posture holding surfaces holding the adapter in a constant posture with respect to the first connector by coming into surface contact with each other;
a resilient holding portion provided on at least one of the first connector and the adapter, the resilient holding portion holding the posture holding surface of the first connector and the posture holding surface of the adapter in a state in contact with each other by a resilient force; and
a guide portion for correcting position shifts of the second connector and the adapter by inclining the adapter while resiliently deforming the resilient holding portion.

2. The connector device of claim 1, wherein:
a first posture holding surface serving as the posture holding surface of the first connector is constituted by a flat surface orthogonal to an axis of the first connector, and
a movable posture holding surface serving as the posture holding surface of the adapter is constituted by a flat surface orthogonal to an axis of the adapter.

3. The connector device of claim 1, wherein a first posture holding surface serving as the posture holding surface of the first connector is formed on a first dielectric constituting the first connector.

4. The connector device of claim 1, wherein a movable posture holding surface serving as the posture holding surface of the adapter is formed on a movable dielectric constituting the adapter.

5. The connector device of claim 1, wherein the resilient holding portion is formed on a movable outer conductor constituting the adapter.

6. The connector device of claim 5, wherein the resilient holding portion includes a contact point portion for electrically conductively connecting the movable outer conductor to a first outer conductor constituting the first connector.
